(19) United States
(12) Patent Application Publication
(10) Pub. No.: US 2017/0106523 A1
(43) Pub. Date: Apr. 20, 2017

(54) ELECTRIC TOOL WITH LIGHTING FUNCTION

(71) Applicant: JENN FENG NEW ENERGY CO., LTD., Taoyuan City (TW)

(72) Inventor: Chih-Ling PAN, Taoyuan City (TW)

(73) Assignee: JENN FENG NEW ENERGY CO., LTD., Taoyuan City (TW)

(21) Appl. No.: 14/885,523

(22) Filed: Oct. 16, 2015

(51) Int. Cl. B25F 5/02; B23Q 17/24; B25B 23/18; F21V 33/00

(52) U.S. Cl. CPC B25F 5/021; F21V 33/0084; B23Q 17/2404; B25B 23/18

(57) ABSTRACT

An electric tool includes a first casing having an upper housing and a second casing having a connection portion fastened with the upper housing and a cone-shaped portion connected to the connection portion in such a manner to define several circumferential recesses on an exterior surface, wherein the cone-shaped portion is truncated and has a diameter that gradually decreases from one end to the other end; a shaft mounted rotatably to a front end of the cone-shaped portion; a light permeable structure including several light permeable elements disposed in the circumferential recesses respectively; and a lighting structure disposed in the connection portion and having several light emitting sources, which are corresponding to and are capable of emitting light rays through the light permeable elements respectively.

### BACKGROUND OF THE INVENTION

1. Field of the Invention

The present invention relates generally to an electric tool, such as an electric drill, and more particularly to an electric tool with lighting function that provides a large range of illumination about a working site so as to facilitate the operation of the electric tool on an object at the working site.

2. The Prior Arts

When operating on a plurality of workpieces, likes tightening bolts, nuts and drilling a hole with drilling bits, with an electric tool, the operator may encounter the difficulty of properly aligning the electric tool relative to a working object if the working object is not fully visible due to insufficiency of illumination at the working site. To eliminate the above-mentioned problem, a lighting structure is installed on the operating body of currently available electric tool so as to facilitate the operator to view the working site properly. U.S. Pat. No. 8,382,308 discloses an electric tool with lighting function that eliminates the prior problem of unable to align the electric tool precisely relative to the working object.

It is noted that the above-mentioned electric tool has only a single light emitting source such that the illumination provided by the sight light emitting source is not enough especially in a narrow working site. In other words, the illumination provided by the single light emitting source cannot create a fully visible working site and hence the operator's eyes cannot clearly and precisely see the working object, thereby causing dangers and aesthenopia (eye fatigue) to the operator.

Another electric tool disclosed by U.S. Pat. No. 8,827,483 includes a lighting structure that is mounted rotatably on a front end of an adjustable rotation flange and the lighting structure consists of a plurality of light emitting sources so as to eliminate the prior disadvantages. However, the illumination range of the lighting structure of the above-mentioned electric tool is limited only to the working site or the working object, but fails to illuminate the ambient surrounding of the working site such that the operator cannot fully observe and judge the ambient surrounding. Therefore, the operator needs an auxiliary lighting device (like a torch or emergency lamp) to illuminate the ambient surrounding, which is against the wishes of the operator.

### SUMMARY OF THE INVENTION

The main objective of the present invention is to provide an electric tool with lighting function that provides a large range of illumination about a working site so as to facilitate the operation of the electric tool on the object at the working site, and the lighting structure can be applied in different electric tools and is not restricted by any operating bits or any configurations of adjustable rotation flanges.

An electric tool with lighting function of the present invention accordingly includes a first casing, a second casing, a shaft, a light permeable structure and a lighting structure.

The first casing includes an upper housing and a handgrip connected to a bottom side of the upper housing.

The second casing is disposed in front of the first casing. The second casing includes a connection portion fastened with the upper housing, a cone-shaped portion having a rear end connected to the connection portion in such a manner to define a plurality of circumferential recesses on an exterior surface and a front end, wherein the cone-shaped portion has a diameter that gradually decreases from the rear end towards the front end.

The shaft is mounted rotatably to the front end of the cone-shaped portion.

The light permeable structure includes a plurality of light permeable elements disposed in the plurality of circumferential recesses respectively.

The lighting structure is disposed within the connection portion of the second casing, includes a plurality of light emitting sources, which are corresponding to and are capable of emitting light rays through the plurality of light permeable elements respectively.

One distinct feature of the present invention resides in that since the plurality of light emitting sources of the lighting structure in the present electric tool provide illumination concentrated on the working site so as to facilitate the aligning of the working bit relative to the working object. At the same time, since the ambient surrounding of the working site is fully illuminated by the plurality of light emitting sources, the operator can clearly observe and judge the ambient surrounding of the working site. The lighting structure of the present invention can be applied in various electric tools without being restricted by the operating bits or adjustable rotation flange, the number of light emitting sources can be increased or decreased depending on the requirements of the electric tool.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a perspective view of an electric tool of the present invention with lighting function;

FIG. 2 shows an exploded and perspective view of the electric tool of the present invention with lighting function;

FIG. 3 shows a lateral side view of the electric tool of the present invention with lighting function;

FIG. 4 shows a front side view of the electric tool of the present invention with lighting function; and

FIG. 5 shows the electric tool of the present invention with lighting function in use.

### DETAILED DESCRIPTION OF THE PREFERRED EMBODIMENT

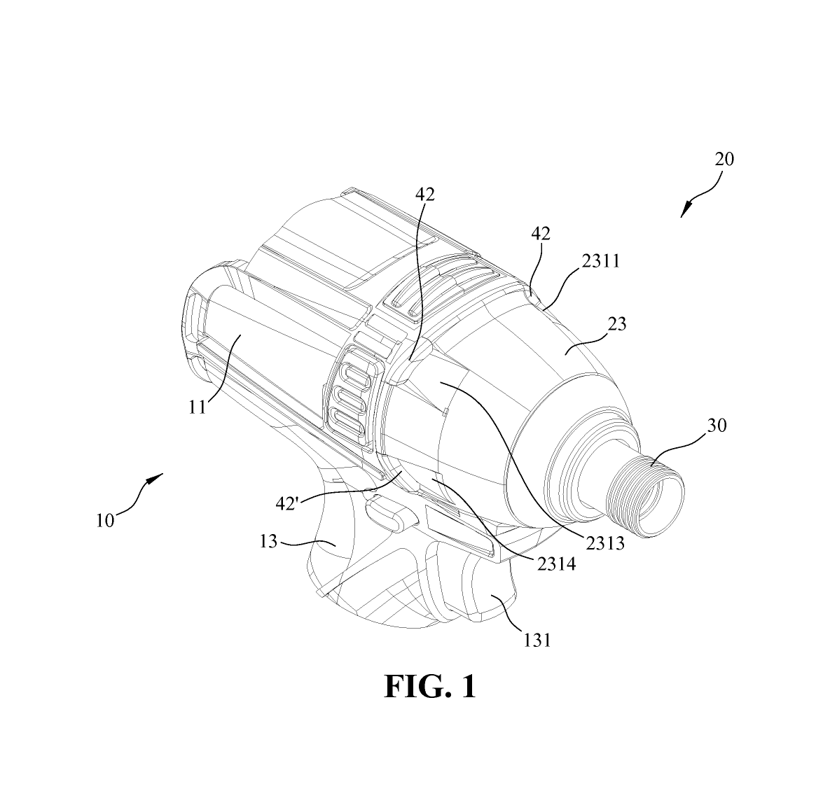

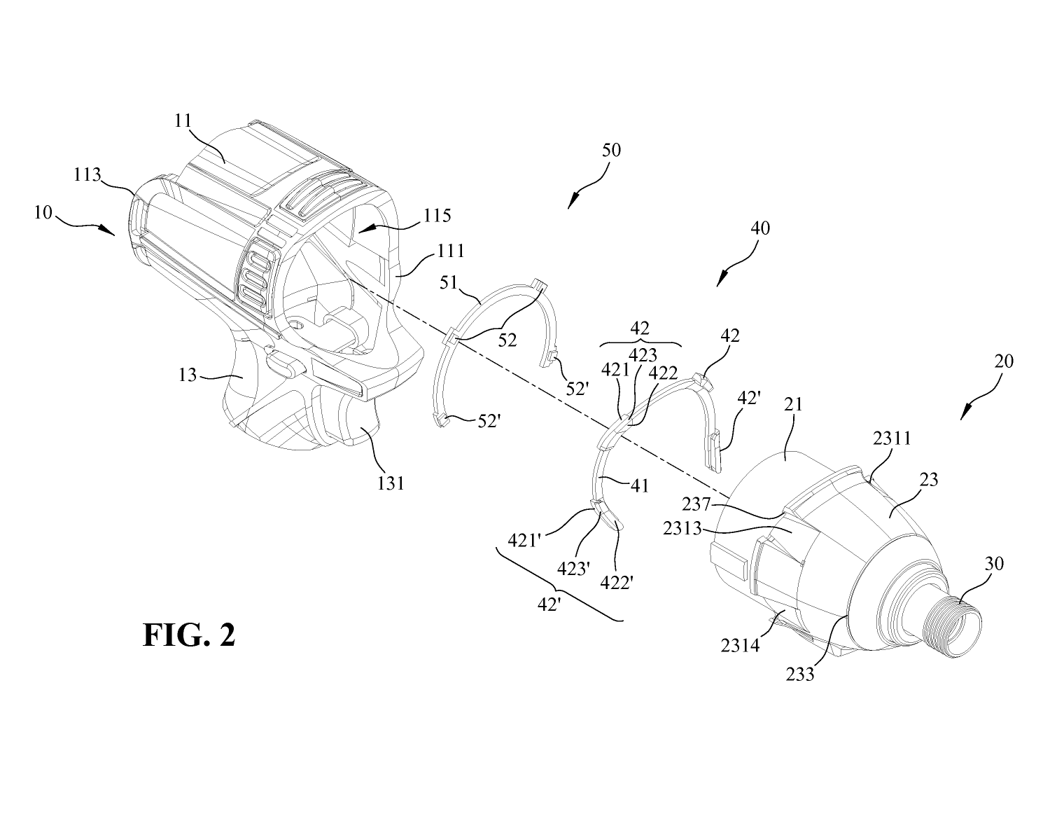

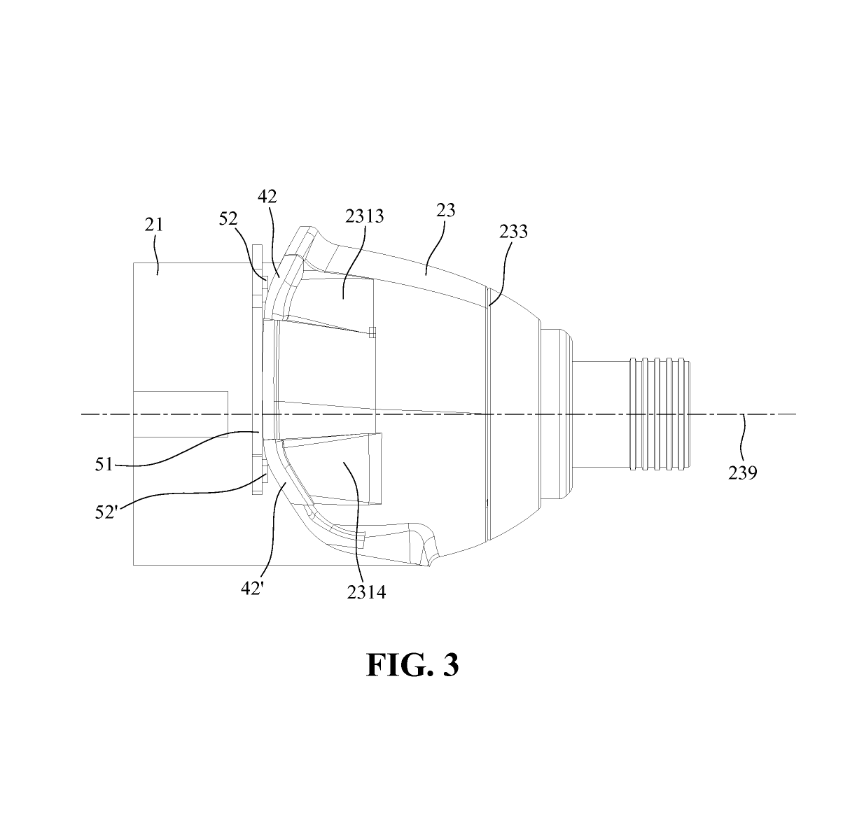

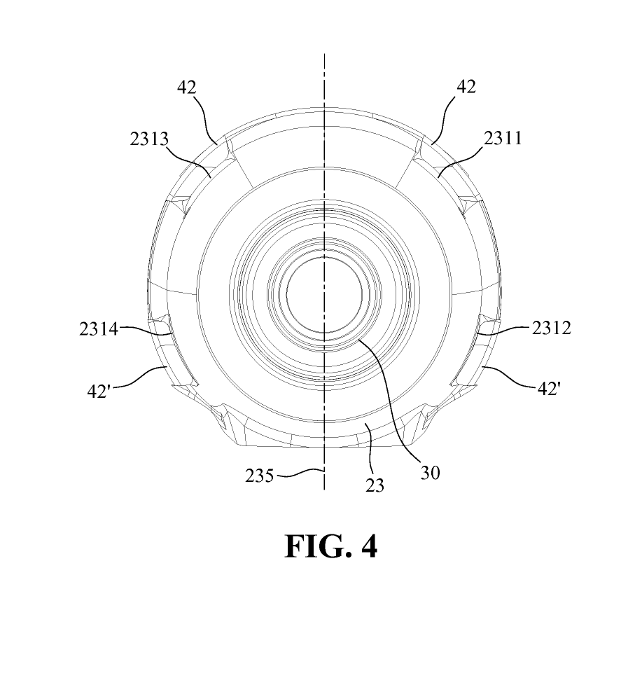

Referring to FIGS. 1-4, wherein FIG. 1 shows a perspective view of an electric tool of the present invention with lighting function; FIG. 2 shows an exploded and perspective view of the electric tool of the present invention with lighting function; FIG. 3 shows a lateral side view of the electric tool of the present invention with lighting function; and FIG. 4 shows a front side view of the electric tool of the present invention with lighting function. As illustrated, the electric tool with lighting function according to the present invention includes a first casing 10, a second casing 20, a shaft 30, a light permeable structure 40 and a lighting structure 50.

The first casing 10 includes an upper housing 11 and a handgrip 13 connected to a bottom side of the upper housing 11. The upper housing 11 has opposite front and rear ends 111, 113 and a receiving space 115 is defined between front and rear ends 111, 113. The handgrip 13 has a press button 131 connected electrically to a power source, such as battery, A/C or D/C current power.

The second casing 20 is disposed in front of the first casing 10, includes a cylindrical connection portion 21 fastened with and extending into the receiving space 115 of the upper housing 11, a cone-shaped portion 23 having a rear end connected with the connection portion 21 in such a manner to abut against the front end of the upper housing 11 so as to define a plurality of circumferential recesses on an exterior surface such that the plurality of circumferential recesses are in spatial communication with the receiving space 115 and a front end 233 spaced from the rear end by a distance. The cone-shaped portion 23 defines an axis 239 and a vertical line 235 extending perpendicularly to the axis. In this embodiment, the cone-shaped portion 23 is generally truncated while the plurality of circumferential recesses are formed on the exterior surface of the cone-shaped portion 23 adjacent to the rear end and consists of a first circumferential recess 2311 extending from 30 degree to 60 degree in a clockwise direction with respect to the vertical line 235, a second circumferential recess 2312 extending from 95 degree to 125 degree in the clockwise direction with respect to the vertical line 235, a third circumferential recess 2313 extending from 30 degree to 60 degree in an anti clockwise direction with respect to the vertical line 235 and a fourth circumferential recess 2314 extending from 95 degree to 125 degree in the anti clockwise direction with respect to the vertical line 235. Since the cone-shaped portion 23 is a truncated cone and has a diameter that gradually decreases the rear end towards the front end. It is to note that in this embodiment, the cone-shaped portion 23 and the connection portion 21 cooperatively define a circumferential fixing channel 237 on the exterior surface adjacent to the rear end thereof Under this condition, the exterior surface of the cone-shaped portion 23 is inclined 10 degree to 20 degree with respective to an axis 239 of the cone-shaped portion 23.

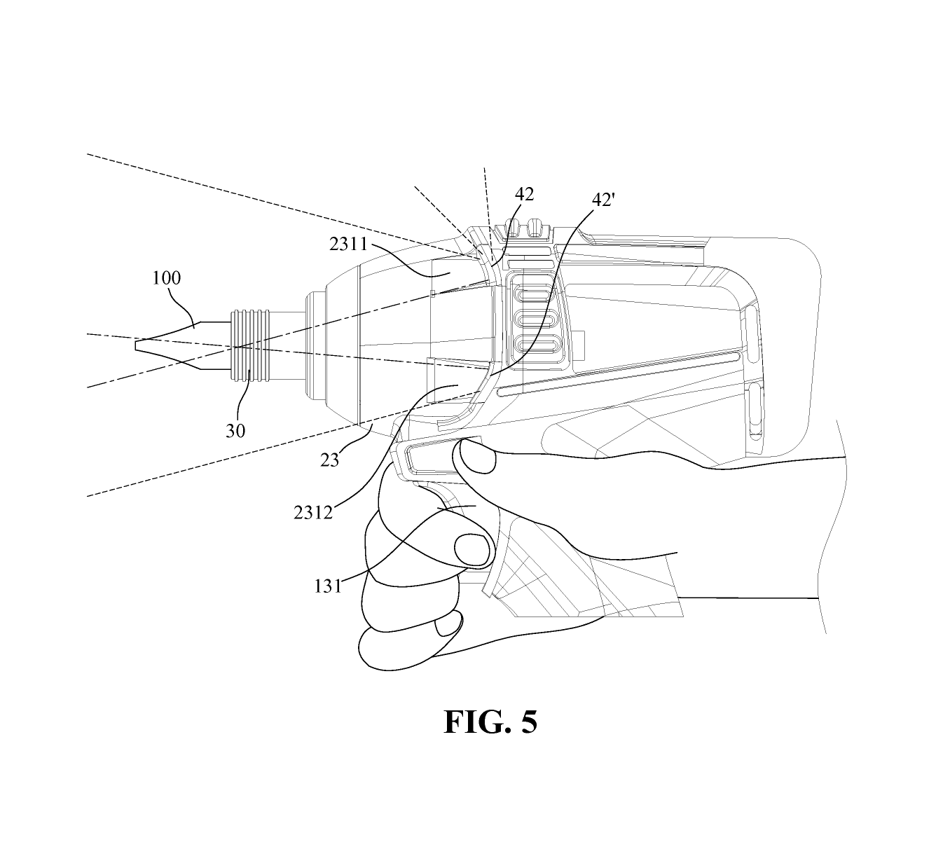

The shaft 30 is mounted rotatably to the front end 233 of the cone-shaped portion 23. The shaft 30 in fact has a clamp (not visible) for clamping an operating bit, such as a nut-turning head or a drilling bit 100, as best shown in FIG. 5. The electric tool of the present invention further includes a driving member, like a motor, disposed with the second casing 20 and is electrically connected with the press button 131 such that after the shaft 30 is mounted rotatably with the front end 233 of the cone-shaped portion 23, the shaft 30 is operably connected with the motor such that activation of the motor upon pressing the press button 131 results in rotation of the shaft 30, hence performing a working operation.

The light permeable structure 40 includes an annular flange 41 and four light permeable elements 42, 42′. The annular flange 41 is disposed circumferentially around the second casing 20. To be more specific, the annular flange 41 is generally C-shaped and is disposed circumferentially in the circumferential fixing channel 237 around the second casing 20 while the light permeable elements 42, 42′ are installed on the annular flange 41 such that they are disposed respectively in the first, second, third and fourth circumferential recesses 2311, 2312, 2313 and 2314. To be more specific, the light permeable elements 42, 42′ are rectangular, square or circular in cross-section. In this embodiment, each of the light permeable elements 42, 42′ has an upper surface 421, 421′, a front surface 422, 422′ facing toward the front end 233 of the cone-shaped portion 23 and an inclined surface 423, 423′ between the upper and front surfaces 421, 422. In this embodiment, the front surface 422, 422′ of the respective light permeable element 42, 42′ is inclined between 60 degrees to 90 degrees with respect to the axis 239 of the cone-shaped portion 23. In another embodiment, the front surface 422, 422′ of the respective light permeable element 42, 42′ is flat and extends perpendicularly with respect to the axis 239 of the cone-shaped portion 23 or is curved with respect to the axis 239 of the cone-shaped portion 23. The shape or configurations of the light permeable elements 42, 42′ should not be only limited to the described ones, but should include any configuration so long as light can penetrate therethrough, such as the light permeable elements 42, 42′ are fully transparent or translucent.

The lighting structure 50 is disposed in the connection portion 21 of the second casing 20, includes a C-shaped circuit plate 51 disposed on the connection portion 21 of the second casing 20 and a plurality of light emitting sources 52, 52′, which are corresponding to and are disposed on the C-shaped circuit plate 51 so as to face toward the light permeable elements 42, 42′ such that the light emitting sources 52, 52′ are capable of emitting light rays through the plurality of light permeable elements 42, 42′ respectively. To be more specific, each of the light emitting sources 52, 52′ defines a light emitting direction tending towards a central portion of a respective one of the light permeable elements 42, 42′. As illustrated, the first casing 10 encloses the lighting structure 50 so as to protect the latter from being damaged. In this embodiment, the plurality of light emitting sources 52, 52′ includes 4 units, two of which are disposed on the exterior surface of the cone-shaped portion 23 adjacent to the rear end at 45 degree in the clockwise direction with respect to the vertical line 235 and at 45 degree in the anti clockwise direction with respect to the vertical line 235 while remaining two units are disposed at 110 degree in the clockwise direction with respect to the vertical line 235 and at 110 degree in the anti clockwise direction with respect to the vertical line 235.

Referring to FIG. 5, which shows the electric tool of the present invention with lighting function in use. Upon activation of the press button 131, the driving member is activated so as to drive the shaft 30, which in turn, rotates the drilling bit 100. It is to note that activation of the press button 131 also results in supply of current to the light emitting sources 52, 52′, that emit light rays passing through the four circumferential recesses 2311, 2312, 2313 and 2314, and the upper surfaces 421, 421′, the inclined surfaces 423, 423′ and the front surfaces 422, 422′ of the light permeable elements 42, 42′ such that the ambient surrounding of the working site is fully illuminated.

An important aspect to note is that the electric tool of the present invention can provide the sufficient and large range of lighting to the ambient surrounding and hence facilitates aligning of the electric tool of the present invention relative to a working object (not visible) in addition to permit the operator to observe and judge the ambient surrounding of the working site.

Another important aspect to note is that since the exterior surface of the truncated cone-shaped portion 23 is inclined from 10 degree to 20 degree with respective to an axis 239 of the cone-shaped portion 23, the light rays emitted from the light emitting sources 52, 52′ are spread out in all directions as best shown in FIG. 5, thereby enhancing the illumination of the working site. Since the lighting structure 50 of the present invention can be applied in various electric tools without being restricted by the operating bits or adjustable rotation flange, the number of light emitting sources 52, 52′ can be increased or decreased depending on the requirements of the electric tool.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electric tool with lighting function, comprising:
a first casing including an upper housing and a handgrip connected to a bottom side of said upper housing;
a second casing disposed in front of said first casing, said second casing including a connection portion fastened with said upper housing and a cone-shaped portion having a rear end connected to said connection portion in such a manner to define a plurality of recesses on an exterior surface and a front end, wherein said cone-shaped portion has a diameter that gradually decreases from said rear end towards said front end;
a shaft mounted rotatably to said front end of said cone-shaped portion;
a light permeable structure including a plurality of light permeable elements disposed in said plurality of recesses respectively; and
a lighting structure disposed in said connection portion of said second casing, said lighting structure including a plurality of light emitting sources, which are corresponding to and are capable of emitting light rays through said plurality of light permeable elements respectively.

2. The electric tool according to claim 1, wherein said cone-shaped portion defines an axis and a vertical line extending perpendicularly to the axis, said plurality of recesses being formed on the exterior surface of said cone-shaped portion adjacent to said rear end and consisting of a first circumferential recess extending from 30 degrees to 60 degrees in a clockwise direction with respect to said vertical line, a second circumferential recess extending from 95 degrees to 125 degrees in the clockwise direction with respect to said vertical line, a third circumferential recess extending from 30 degrees to 60 degrees in an anti clockwise direction with respect to said vertical line and a fourth circumferential recess extending from 95 degrees to 125 degrees in the anti clockwise direction with respect to said vertical line.

3. The electric tool according to claim 2, wherein said plurality of light emitting sources includes 4 units, two of which are disposed on the exterior surface of said cone-shaped portion adjacent to said rear end at 45 degrees in the clockwise direction with respect to the vertical line and 45 degrees in the anti clockwise direction with respect to the vertical line while remaining two units are disposed at 110 degrees in the clockwise direction with respect to the vertical line and 110 degrees in the anti clockwise direction with respect to the vertical line.

4. The electric tool according to claim 1, wherein said light permeable structure includes an annular flange disposed circumferentially around said second casing while said plurality of light permeable elements are installed on said annular flange.

5. The electric tool according to claim 4, wherein said connection portion and said rear end of said cone-shaped portion cooperatively define a circumferential fixing channel on the exterior surface adjacent to said rear end thereof, said annular flange being received in said circumferential fixing channel with said plurality of light permeable elements being exposed from said circumferential fixing channel.

6. The electric tool according to claim 1, wherein said exterior surface of said cone-shaped portion is inclined 10 degrees to 20 degrees with respective to an axis of said cone-shaped portion.

7. The electric tool according to claim 1, wherein said light permeable elements are rectangular, square or circular in cross-section.

8. The electric tool according to claim 1, wherein each of said light permeable elements has an upper surface, a front surface facing toward said front end of said cone-shaped portion and an inclined surface between said upper and front surfaces.

9. The electric tool according to claim 8, wherein said front surface of the respective light permeable element is inclined between 60 degrees to 90 degrees with respect to an axis of said cone-shaped portion.

10. The electric tool according to claim 9, wherein said front surface of the respective light permeable element is flat and extends perpendicularly with respect to the axis of said cone-shaped portion or is curved with respect to the axis of said cone-shaped portion.

11. The electric tool according to claim 1, wherein said light permeable elements are fully transparent or translucent.

12. The electric tool according to claim 1, wherein each of said plurality of light emitting sources define a light emitting direction tending towards a central portion of a respective one of said light permeable elements.

13. The electric tool according to claim 1, wherein said lighting structure further includes a C-shaped circuit plate disposed on said connection portion of said second casing, said plurality of light emitting sources being installed on said C-shaped circuit plate.

14. The electric tool according to claim 1, wherein said upper housing defines a receiving space, said connection portion of said second casing being inserted fittingly into said receiving space while said lighting structure is disposed in said receiving space so as to be enclosed by said upper housing, said plurality of recesses being spatially communicated with said receiving space.
